(19) United States
(12) Patent Application Publication
(10) Pub. No.: US 2007/0226146 A1
(43) Pub. Date: Sep. 27, 2007

(54) System and method for maintaining a history of transferable and updatable media

(76) Inventor: George Eino Ruul, Applecross (AU)

Correspondence Address: CARR & FERRELL LLP, 2200 GENG ROAD, PALO ALTO, CA, 94303, US

(21) Appl. No.: 11/586,096

(22) Filed: Oct. 25, 2006

Related U.S. Application Data
(60) Provisional application No. 60/785,655, filed on Mar. 24, 2006.

(51) Int. Cl. G06Q 99/00

(52) U.S. Cl. 705/51

(57) ABSTRACT

Embodiments of the present invention provide exemplary systems and methods for maintaining a media history. The exemplary system comprises a tracking module at a user device configured to determine a media status. The tracking module is configured to determine whether media has been updated, customized, or transferred after being received at a local location. In exemplary embodiments, the media status may be associated with, or indicate, a user identifier, a transfer-from identifier, a source of the media, an original publisher of the media, a version of the media, a transfer time of the media, and a user preference. The system also comprises a monitor module at a vendor or a media provider configured to receive the media status, and store the media status in a history database. A history module may provide a graphical representation of the media status to a requester.

### CROSS REFERENCE TO RELATED APPLICATIONS

The present application claims the priority benefit of U.S. Provisional Patent Application No. 60/785,655, filed Mar. 24, 2006 and entitled “Dynamic and Interactive Advertising System,” which is herein incorporated by reference. The present application is related to co-pending U.S. patent application Ser. No. ______ entitled “System and Method for Providing Dynamic Media,” U.S. patent application Ser. No. ______ entitled “System And Method For Providing And Maintaining Dynamic Media,” U.S. patent application Ser. No. ______ entitled “System and Method For Transferring Media” all filed concurrently with the present application. The present application is further related to co-pending U.S. patent application Ser. No. 11/214,515 entitled “Managed E-Commerce Trading,” filed Aug. 29, 2005; U.S. patent application Ser. No. 11/250,996 entitled “E-Commerce with Direct Access to Real-Time Inventory,” filed Oct. 14, 2005; U.S. patent application Ser. No. 11/251,316 entitled “Managed E-Commerce Trading Environments,” filed Oct. 14, 2005; and U.S. patent application Ser. No. 11/258,419 entitled “Content Monitor,” filed Oct. 24, 2005, all of which are herein incorporated by reference.

### BACKGROUND OF THE INVENTION

1. Field of the Invention

The present invention relates generally to providing online media, and more particularly to systems and methods for maintaining a history of online media.

2. Description of Related Art

The Internet has developed into a dominant force in the global business market. Media such as movie clips, sound or music clips, articles, essays, recipes, advertisements, and advice columns may be posted by content providers for consumers to view. Businesses may now sell products, deal with vendors, post advertisements, promote items, and conduct other business activities via the Internet. Ideally, advertisers and content providers are interested in tracking media posted on the Internet to gauge consumer interest level, price points, and the like.

Currently, online consumers can be tracked using “cookies” or other spyware downloaded from websites that a consumer has visited. However, these programs only track consumer habits and do not focus on actual consumer interest in specific media. Additionally, consumers use security software to block spyware and cookies from being installed and/or to erase spyware or cookie downloads.

Presently, online media are typically not suitable for later viewing. With the advent of new technology, consumers will be able to save media and refer media to others more easily. As a result, advertisers and content providers will be interested in tracking which media a user saves in order to push subsequent media to the user. Advertisers and content providers may also be interested in tracking transfers of media between consumers to determine additional relevant audiences.

Therefore, there is a need for a tracking system that is able to maintain a history of online media.

### SUMMARY

The present invention provides exemplary systems and methods for maintaining a history of media. The exemplary system comprises a tracking module at a user device configured to determine a media status. The tracking module is configured to determine whether media has been updated, customized, or transferred after being received at a local location. The system also comprises a monitor module at a vendor or media provider configured to receive and store the media status in a history database. A history module provides a graphical representation of the media status to a requester.

The media status comprises a media identifier. In exemplary embodiments, the media status is associated with or indicates the source of the media, the source of the media received at the local location, the transfer time of the media, or the version of the media. In other embodiments, the media status may comprise a user identifier or a transfer-from identifier indicating a user who transferred the media. In further embodiments, the media identifier comprises a media name and a version number.

### BRIEF DESCRIPTION OF THE DRAWINGS

FIG. 1 is an environment in which embodiments of the present invention may be practiced;

FIG. 2 is a block diagram of an exemplary online services server according to one embodiment;

FIG. 3 is a block diagram of an exemplary user device comprising a core services module;

FIG. 4 is a block diagram of an exemplary user media engine;

FIG. 5A is a block diagram of an exemplary media;

FIG. 5B is an illustration of a sample media;

FIG. 6 is a flowchart of an exemplary method for media that is updated and transferred; and

FIG. 7 is a sample table used to maintain a history of the media.

### DESCRIPTION OF EXEMPLARY EMBODIMENTS

Embodiments of the present invention provide systems and methods for maintaining a history of transferable and/or updatable media. Exemplary embodiments maintain a record of media, wherein the media may be updatable, customizable, and/or transferable to other users in a real-time online environment. In exemplary embodiments, the online environment enables a vendor or media provider to track the transfer of media to a user's computing device and to other users. Some embodiments may also track changes in the information appearing in media as it is customized to specific users. Tracking enables the vendor or media provider to determine, for example, which promotions effectively attract customers, which groups are interested in the vendor's or media provider's products or services, whether efforts aimed at retaining existing customers are effective, and the like.

Unlike prior art systems, the present system is tailored to track online media that are selected by the user for later review and/or transferred from one user to other users. Tracking creates a history of the media which is valuable to the vendor or media provider by providing more information about its customers. The media history also provides information to a vendor or advertiser that can be used to determine which media to push to a specific user in the future.

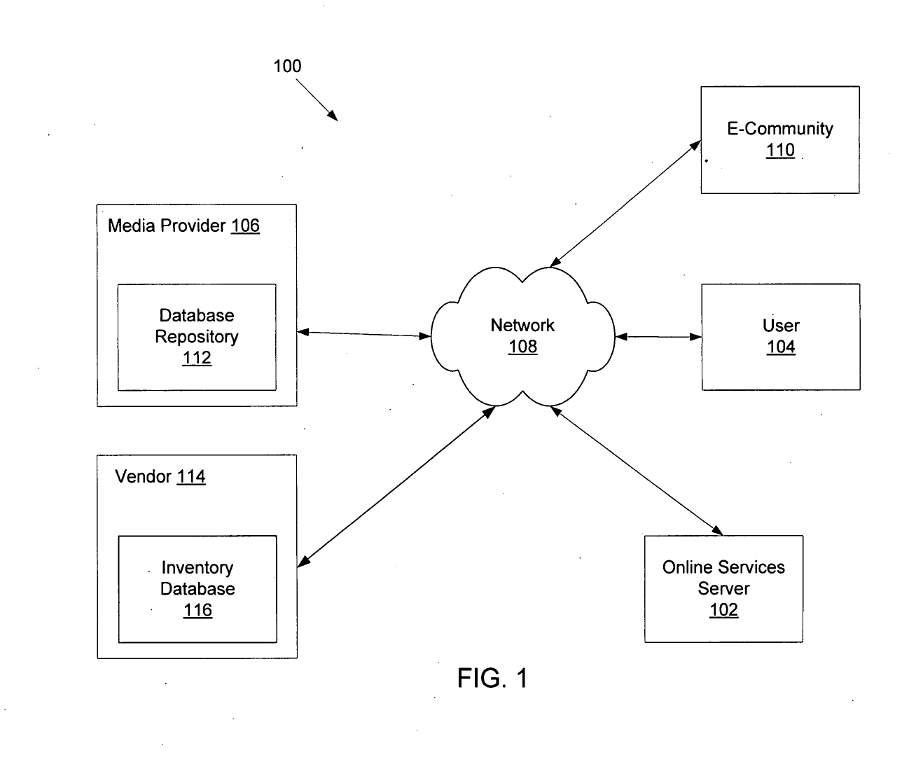

FIG. 1 shows an exemplary environment 100 in which embodiments of the present invention may be practiced. The environment 100 comprises an online services server 102, at least one user 104 (i.e., individual on the network 108), and at least one media provider 106 all coupled for communication via a network 108. In exemplary embodiments, the network 108 may be the Internet, wide area network, local area network, or any other type of communication network. The online services server 102 and a computing device of the user 104 will be discussed in more detail below. In some embodiments, one or more optional e-communities 110 (i.e., groups of users sharing a common interest) may also be present in the environment 100.

The present environment 100 allows a plurality of users 104, media providers 106, and optional e-communities 110 to interact with each other, including dragging and dropping or transferring media over the network 108. “Drag and drop” as utilized herein refers to selecting and moving a copy of the transferable media to a designated location, creating a copy of the transferable media at the designated location, or creating a direct link to the transferable media at the designated location. The interactions may result in online transactions or exchange of information.

In the present embodiment, the media provider 106 provides media to the environment 100. The media provider 106 may comprise news outlets, content providers, marketing firms, advertising firms, or any entity which may manage online advertising and marketing strategies. In an embodiment where the media provider 106 provides marketing or advertising support for the vendor 114, the media provider 106 may be connected to the network 108 directly or communication via the vendors 108. For example, the media provider 106 may generate media for the vendor 114 to post to the network 110. The media provider 106 may also have access to a media history to track user habits using, for example, sales and usage statistics.

The media may be presented, for example, on webpages, pop-ups, and banner ads. Additionally, the media may be presented in e-mail communications or shared between members of the environment 100 (e.g., users 104, media providers 106, and optional e-communities 110). Updates to the media may be provided via a database repository 112. In exemplary embodiments, the database repository 112 is a real-time database comprising up-to-the-minute data. The database repository 112 may also comprise a media database comprising different media the media provider 106 may provide.

Media may comprise any item of information found on the network 108 that is configured to function with embodiments of the present invention. For example, the media may be an advertisement or news article that is identified as one that can function in the environment 100. The identifier may be a symbol or any other indicator that the media is operable in the environment 100.

In a specific embodiment, the media provider 106 is a vendor 114. In exemplary embodiments, the media from the vendor 114 (e.g., advertisement) is updatable with vendor information from a database repository comprising an inventory database 116. The exemplary inventory database 116 is a current, real-time database maintained by the vendor 114, which comprises inventory information including inventory amount and pricing. In exemplary embodiments, the inventory database 116 is located at the vendor's location and tracks pricing and movement of the vendor's inventory. In some embodiments, a media provider 106 may be coupled to the vendor 114 to provide the media on behalf of the vendor 114.

In exemplary embodiments of the present invention, the members of the environment 100 (e.g., communicating entities) communicate over the network 108 using a specialized GUID-over-IP transport mechanism. The specialized transport mechanism allows the communicating entities to be coupled through a network of internal and external routers, proxies, and firewalls without requiring reconfiguration of various communications equipment. Routing management may be used to control pathways taken by the communicating entities. This may be an important feature for communicating entities that are sensitive about the content of the media. Additionally, load balancing and N-tier construction allow for efficient scale out rather than scale up implementations.

The coupled computing devices of the members of the environment 100 each comprise a core services module which allows operation of embodiments of the present invention and for customization. The core services module will be discussed in more detail below.

In exemplary embodiments utilizing a standard browser, when a media is selected, a script such as a Java script (e.g., a Visual Basic script) embedded into a HTML section of the media is activated (e.g., JAVA functions or active X control). This script interacts with the core services module at the user 104 device, which recognizes that the media has a particular media identifier and a parent identifier. A connection is then made via the script and the core services module to the media provider 106 identified by the parent identifier, which can then provide instructions and data to display a version of the media at the user 104 device. The data may allow for an exact duplicate of the media the user 104 selected or a customized version of the media. While the result may appear to be a “drag and drop” in these embodiments, in reality, it is an instruct and recreate process. In a further embodiment, the media as displayed on a web page, for example, is extracted and utilized to display the media on the user's desktop, even if the user is offline at that time. However, any action based on a real-time link is curtailed until reconnection occurs.

In embodiments utilizing an online services application, a version of the media may be “copied and pasted.” That is, every component that is embedded in the media can be copied and moved over to the designated location.

In yet further embodiments, the media may literally be “dragged and dropped” from a first location to a second location (i.e., taken from the first location and dropped onto a second location). For example, a media may be dragged from the desktop of the user 104 to an e-mail to be sent to another user. In these embodiments, the trigger or select event is a “drag and drop” command received from the user 104.

In a further embodiment, a media manager (not shown) may be coupled to the network 108 of the online system of FIG. 1. The media manager arranges for the vendor 114 to pay a fee or commission to the e-community 110 or user 104, for example, for sales generated by advertisements/media transferred by the e-community 110 or the users 104.

While some of the above embodiments describe a media constructed in, or containing at least a section of, HTML, alternative embodiments of the media may be constructed using other formats. For example, the media may be constructed using Macromedia's Flash, XML using XSLT, or any other potential construct language that can trigger the select event. The “select” event may cause the media to be transferred, copied, or dropped, or may cause a connection to the media provider 106 to be established.

It should be noted that the environment 100 of FIG. 1 is exemplary. Alternative embodiments may comprise more or fewer components. For example, more than one online services server 102 may be provided (e.g., regionally based). Furthermore, any number of users 104, media providers 106, e-communities 110, and vendors 114 may be coupled in communication in the environment 100 at any time.

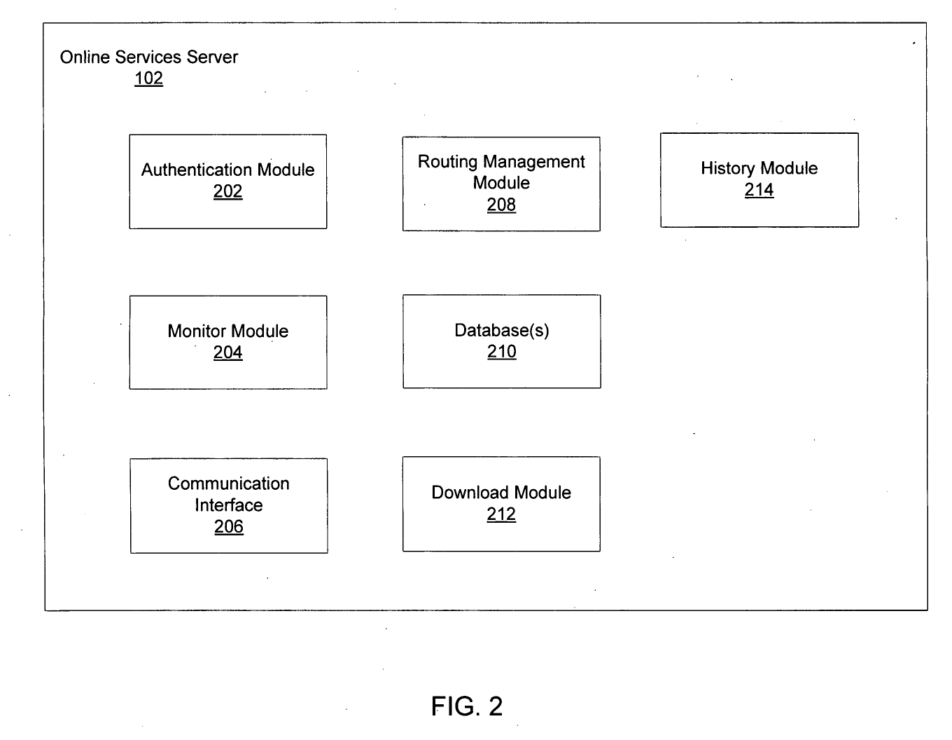

Referring now to FIG. 2, the online services server 102 is shown in more detail. In certain embodiments, the online services server 102 may comprise an e-commerce server. In exemplary embodiments, the online services server 102 comprises an authentication module 202, a monitor module 204, a communication interface 206, a routing management module 208, at least one database 210, and a download module 212. In further embodiments, the database 210 may comprise a plurality of databases, each storing designated data. For example, the optional online services server 102 may comprise an authentication database (e.g., containing user information), a monitor database (e.g., storing transaction information), a history database (e.g., tracking updatable and transferable media), and an online services application database (e.g., storing application plug-ins and modules for e-commerce, e-community, or other applications that may be accessed and downloaded onto the user 104 and vendor 114 devices). In alternative embodiments, the database 210 is located outside of the online services server 102 but is coupled thereto. It should be noted that the online services server 102 may comprise other components not relevant to the functionalities of embodiments of the present invention.

The exemplary authentication module 202 authenticates users 104, media providers 106, e-communities 110 (e.g., an administrator for the e-community 110), and vendors 114. When these members first register with the online services server 102, the members provide data such as a user name, password, and contact information. This information is then stored in the database(s) 210.

Subsequently, authentication may occur seamlessly and unobtrusively to the members. In one embodiment, the authentication process comprises verifying the user name and password supplied by the member with those stored in the database(s) 210. Alternative methods for authenticating members may be utilized, such as, for example, verifying IP addresses in communications sent between members. The authentication information may be received via the communication interface 206. The authentication module 202 then compares the received authentication information to authentication information stored in the database(s) 210. As such, members accessing and utilizing the environment 100 are known to the online services server 102, and based on permissions associated with the member, are enabled to interact with other members. In some embodiments, the authentication module 202 allows for transfer of media.

In alternative embodiments, the authentication module 202 is optional or not required in order for embodiments of the present invention to be practiced. In these embodiments, a user 104, media provider 106, e-community 110, and/or vendor 114 does not need to be registered/authenticated in order to support media functionalities. For example, registration/authentication may be performed automatically without the user 104 being required to submit any personal information. In these embodiments, each media is an instantiation of a node of a closed/private community comprising the media provider 106 and all media (from the media provider 106) currently in existence. The media provider 106 hosts the ‘authentication process’ and it may be different for each media accessed by the user 104. Thus, an instantiation is authenticated each time as distinct from the user 104 or computing device, itself.

As such, the authentication process may occur during an initial connection with the system (e.g., login at a start of a session). In alternative embodiments, authentication may occur at other times, such as when the user 104 interacts with a media. In further embodiments, the user 104 does not need to be authenticated or logged into the online services server 102 in order to interact with the media (e.g., view, transfer, or receive updates to the media).

In some embodiments, authentication of the user 104 allows for customization of media viewed by the user 104. Because the user 104 is now logged in with the online services server 102 and/or the media provider 106, updates from the media provider 106 may be provided to the authenticated user 104. Additionally, the online services server 102 may monitor media viewed by each user 104 and track actions associated with each user 104 with regards to media (e.g., transferring a media to other users 104, purchasing via the media, etc.), and maintain a history of the media.

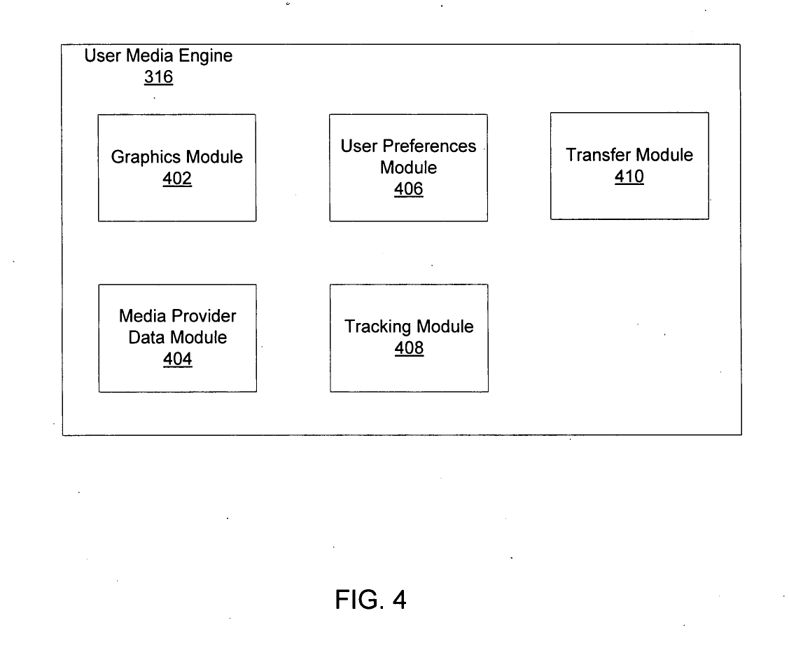

In some embodiments, the monitor module 204 is able to monitor media that have been transferred onto a user's desktop, media that have been transferred between users 104 or within e-communities 110, media that have been updated by the vendor 114, and/or media that have been customized to the user 104. For example, the optional online services server 102 receives copies of media being sent in communication packets between the vendors 114, media providers 106, e-communities 110, and users 104. The monitor module 204 monitors these media via these packet copies. In some embodiments, the monitor module 204 may receive tracking information from each user's computing device, as is described in connection with FIG. 4. Alternatively, the monitor module 204 may be located within the vendor 114 or media providers 106.

Some embodiments provide for a searchable query, via the monitor module 204, of the tracked media information in the database 210. The query may be conducted by the vendor 114 or the media provider 106. Thus, for example, the vendor 114 may communicate with or access the optional online services server 102 and enter query terms to find data about a specific media or version of the media. The monitor module 204 may then access the data in the database 210 for the requested information.

Additionally, the monitor module 204 may review and verify different aspects of the packet copy information. In one embodiment, the monitor module 204 reviews and verifies the identities of the user 104 and vendor 114. In a further embodiment, the monitor module 204 prepares statistical reports based on the contents of the packet copies. For example, for a particular vendor 114, the monitor module 204 can determine how many, how much, and/or when particular media were transferred onto a user's desktop over a certain time period. Statistics may also be determined for media transfers within e-communities 110 or between users 104. For example, an e-community's website may be monitored and statistical reports generated thereon. Statistical reports regarding any aspect of transactions between two or more parties (e.g., users 104 and/or media provider 106) are within the scope of exemplary embodiments of the present invention.

The statistical reports may then be provided to the vendor 114, the media provider 106, or any other requester. The statistical reports may be stored in the database 210 for the requester to access, electronically delivered periodically to the requester, or delivered via any other means and on any schedule to the requester. In one embodiment, the requester may access the online services server 102 and, via the monitor module 204, input terms for the statistical analysis report.

The routing management module 208 provides routing instructions that allow for control of pathways taken by, for example, communications containing transferred media. In one embodiment, the use of routing instructions allows the system to monitor the communications by routing a copy of the media being transferred to the online services server 102.

Alternatively, the communications, including media, may be routed to the online services server 102 prior to their final destination. For example, the routing protocol associated with a communication may provide for a third address (wherein the first address is the sender address and the second address is the receiver address). By redirecting the communication through the third address (e.g., online services server 102 or an administrator), the system can monitor the media in the communication.

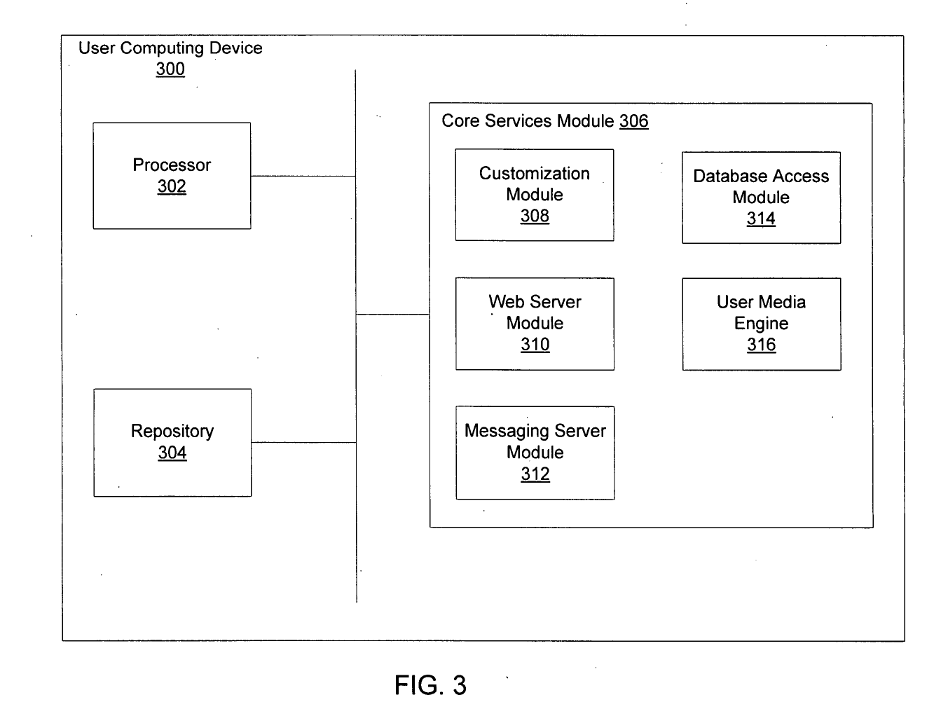

The online services server 102 further comprises a download module 212. The download module 212 provides applications and components (e.g., from the online services application database) which create a core services module, as described in more detail in FIG. 3, at the device of the user 104, the media providers 106, the e-community 110, and/or the vendor 114. In alternative embodiments, components of the download module 212 may be embodied, for example, on a CD-ROM for easy distribution. The download module 212 may provide a license agreement, registration, and product updates. In some embodiments, the download module 212 will distinguish a downloading member as a user 104, media provider 106, e-community 110, or vendor 114, so as to provide a different version of the core services module component to each type of member. In some embodiments, the core services module components may be the same for all members, while alternative embodiments may comprise different components. Once downloaded by the member, the core services module is configured to meet the needs of the downloading member.

The online services server 102 may further comprise a history module 214. In certain embodiments where the history database is maintained at the online services server 102, the history module 214 is configured to maintain a history table for each media it tracks and reproduce the history table for viewing. The history module 214 may also generate an updated media identifier or part of an updated media identifier, as discussed herein, when a new media status is received from the user 104. In alternative embodiments, the history database and the history module 214 are located at the vendor 114 or media provider 106. In yet a further embodiment, the functions of the history module 214 may be performed by the monitor module 204.

Referring now to FIG. 3, an exemplary user device 300 is shown. The user device 300 is operated by the user 104 to access the network 108 and may comprise a digital device, a mobile phone or device (e.g., thin clients), or any other wired or wireless device that is enabled to receive information via the network 108. The exemplary user device 300 comprises a processor 302, a repository 304 or other data storage, and a core services module 306 which may be stored in memory or in the repository 304. In exemplary embodiments, the core services module 306 is downloaded from the online services server 102 and installed on the user device 300. Alternative embodiments may comprise more, less, or functionally equivalent components. For example, some of the components of the exemplary user device 300 may be optional.

In some embodiments, the user core services module 306 is downloaded from the online services server 102 via the download module 212 and is seamlessly integrated into the user computing device 300. In exemplary embodiments, the core services module 306 is downloaded when an online services application is downloaded. For example, the core services module 306 is downloaded when a user 104 downloads an e-commerce application or an e-community application as described in related U.S. patent application Ser. No. 11/214,515 entitled “Managed E-Commerce Trading,” and U.S. patent application Ser. No. 11/251,316 entitled “Managed E-Commerce Trading Environments,” which are incorporated by reference. That is the core service module 306 is an inherent part of all online services applications provided by the online services server 102. Once the core services module 306 is installed on the user computing device 300, regardless of whether an online services application is running, interaction with media is enabled. In some embodiments, the running of an online services application will enable further functionalities of the media, such as the “drag and drop” function. In alternative embodiments, the core services module 306 may be downloaded separate from any online services application (e.g., when the user 104 first interacts with a media).

The core services module 306 may comprise a customization module 308, a web server module 310, a messaging server module 312, a database access module 314, and a user media engine 316. In some embodiments, the core services module 306 may also comprise a specialized browser technology optimized for communication using the Internet without depending on existing HTML/XML browser technology.

In exemplary embodiments, the customization module 308 maintains and updates a list of user preferences including preferred advertisers, media providers 106, or vendors 114 as well as established relationships with e-communities 110. This list may be received directly from the user 104 via, for example, responses to a survey or other data. Additionally, the customization module 308 may automatically populate the list based on a history of media that the user 104 has dragged and dropped (e.g., downloaded and stored), viewed, purchased from, or transferred in the past, including media that have been received by the user 104 from other users 104 or transferred within e-communities 110 that the user 104 belongs to. In some embodiments, the user preference list maintained and updated by the customization module 308 is stored in database 304. In further embodiments, the list may be used, for example, to customize media for the user 104.

In some embodiments, the user 104 may establish relationships with e-communities 110 by transferring media within the e-community 110 or dragging and dropping media from the e-community 110. This established relationship may be used by the vendors 114 or media providers 106 to update existing media or push new media to the user 104 and the optional e-community 110.

A web server module 310 allows web-based interactions with other system installations. Additionally, the web server module 310 may include messaging or Voice-over Internet Protocol (VoIP) technology.

An exemplary messaging server 312 ensures robust communication with other community members such as other users 104, vendors 114, media providers 106, or e-communities 110. The exemplary messaging server 312 may receive and process a command from the user 104 to transfer the media to another user 104 or to share the media within the e-community 110. Additionally, the messaging server 312 may provide communication to the media provider 106 via a link associated with the media to a media provider's website or using Voice over Internet Protocol (VoIP), as will be discussed in more detail below.

In some online services application enabled embodiments, the database access module 314 provides access to real-time information and updates in the media provider's database repository 112 or vendor's inventory database 116 such as updated news, directory information, inventory, pricing, and the like. This information may be used by the user media engine 316 to update media to reflect remaining inventory or pricing, for example. In alternative embodiments, the data access module 314 is optional or not required.

The user media engine 316, further described in FIG. 4, is configured to facilitate tracking of media the user 104 interacts with. The user media engine 316, for example, manages data to facilitate dragging and dropping, updating, customizing, transferring, and maintaining a history of media.

Referring now to FIG. 4, a block diagram of the exemplary user media engine 316 is shown. In various embodiments, the user media engine 316 may facilitate the transfer of media onto the user's desktop, customization of the media, and/or transfer of the media to other users 104. The media engine 316 may comprise a graphics module 402, media provider data module 404, user preference module 406, tracking module 408, and transfer module 410. In alternative embodiments, the media engine 316 may comprise more, less, or functionally equivalent modules.

The exemplary graphics module 402 processes data, including static data, in order to generate a graphical representation of the media at an indicated location. The static data may include a media provider's logo, text or images, and an area of the media. In embodiments where the media is customizable, the graphics module 402 uses the static data to create a template. The graphics module 402 then incorporates media provider 106 and user 104 information, according to user preferences, into the template to generate a customized copy of the media.

In embodiments with customizable media, the exemplary media provider data module 404 is configured to interact with the media provider 106 in order to customize the media. According to exemplary embodiments, the media is customized by the media provider 106 based on user preferences. In some embodiments, the selection of a media (e.g., “drag and drop” or activation of a link on a dynamic media) acts as a trigger for the media provider data module 404 to communicate user preferences, which may include past behavior, to the media provider 106 in order to receive a copy of the dynamic media that has been customized to the user 104.

Alternatively, the media provider 106 may request the user preference information from the media provider data module 404. The media provider data module 404 may transmit a list of preferences from the user preferences module 406 which the media provider 106 processes to generate a customized version of the media. The media is then received by the media engine 316 (e.g., via the media provider data module 404) for display. For example, if a user has purchased a travel package to Europe from the media provider 106 in the past, the media provider data module 404 may send this past behavior information to the media provider 106. The media provider data module 404 may then receive data limited to a selection of books within a European travel genre in a customized version of the selected media.

In alternative embodiments, the media provider data module 404 receives or obtains data from the media provider 106 and merges the data with the static data. In some embodiments, the media provider data module 404 may select data from a larger set of data received from the media provider 106. For example, if a user's language preference is Spanish, the media provider data module 404 may select a Spanish-language version of the media instead of an English version. The selected data is then merged with the static data to generate the customized version of the media at the user computing device 300.

In other embodiments, the media provider data module 404 may receive a link to a copy of the media from the media provider 106. As such, no actual version of the media (e.g., media data) may be received by the user 104. The link may comprise an HTML address or a feed such as an RSS feed, an Atom feed or the like. In these embodiments, when the user clicks or otherwise activates the link, the media provider data module 404 communicates with the media provider 106 to facilitate display of a version of the media to the user 104.

In customizable media embodiments, the user preferences module 406 accesses the list maintained by the customization module 308 to determine one or more user preferences to incorporate into the media template or to send to the media provider 106. For example, a user's geographic location may be used to display a map to the nearest store of a vendor 114. In a further example, the user's geographic location may be used to obtain local pricing information from the vendor 114. In this example, the user preference module 406 works with the media provider data module 404 to obtain the pricing information from the inventory database 116. The user preference module 402 then incorporates the user information into the media.

In alternative embodiments, the media may not be customized to the user 104. In these embodiments, the data received by the media provider data module 404 is comprised of static media data, and the user preference module 406 is not required.

The exemplary tracking module 408 maintains a history of one or more media that the user media engine 316 interacted with (e.g., created, transferred, viewed, deleted etc.). After each subsequent update, customization, or transfer of the copy of the media, the tracking module 408, in some embodiments, transmits data related to the update, customization, and/or transfer of the copy of the media to a history database (e.g., database 210 of FIG. 2, database 304 of FIG. 3, and/or a database at the vendor 114 or media provider 106 associated with the media). In alternative embodiments, the transmission of status data may occur at any time, for example, at the request of the online services server 102 or after a certain amount of the status data is accumulated by the tracking module 408.

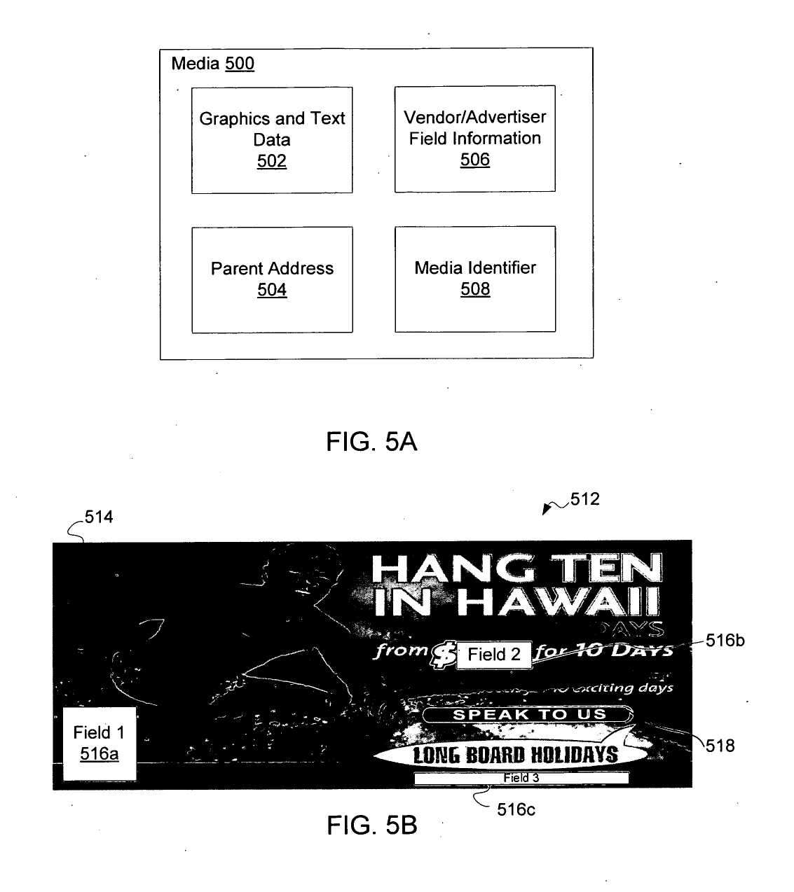

The tracking module 408 may track the data received by the graphics module 402 when the copy of the media is first generated by the user media engine 316 (e.g., downloaded or saved on the user device 300). The tracking module 408 may also record transfer history data including the source of the copy of the media (e.g., a user 104, an e-community 110, a vendor 114, or a media provider 106) and the time of the transfer. After each subsequent media update, or customization, the tracking module 408 transmits data regarding the media customization to the history database, to the vendor 114, the media provider 106, and/or to the monitor module 204 (FIG. 2). The tracking module 408 may also generate or receive a media identifier, or part of a media identifier, from the optional online services server 102, a media provider 106, or a vendor 114 each time the media is transferred or changed. Media identifiers will be discussed in detail in connection with FIG. 5A and FIG. 5B.

In alternative embodiments, the tracking of the media may be performed by the online services server 102 or the media provider 106. For example, the history module 214 or the monitor module 204 of the online services server 102 may receive tracking data transmitted by, or pull tracking data from, the core services module 306 in response to an update, transfer, or customization. In other embodiments, the media provider 106 may comprise one or more modules analogous to the history module 214 and the monitor module 204 that are configured to receive, store, process, and/or graphically represent the data.

The exemplary transfer module 410 manages the movement of copies of the media. For example, when a script is activated on a selected media, the transfer module 410 recognizes the media identifier and the parent identifier, and initiates the connection with the media provider 106. In exemplary embodiments, the transfer module 410 selects the media and indicates a location on the desktop where a copy of the selected media should be placed after generation by the graphics module 402 according to instructions received from the media provider 106. In further examples, the transfer module 410 moves or copies selected media or copies of the media to e-mail communications or websites (e.g., an e-community 110 website). Alternatively, the transfer module 410 may transmit a message to the media provider 106, indicating that a copy of the media or a link to the media is to be transmitted to another user 104 or to an e-community 110.

Alternative embodiments may utilize a different number of modules, or modules that are functionally equivalent to the user media engine 316. For example, the user preferences module 406 and/or the media provider data module 404 may be functionally combined with the graphics module 402 to form a single module. The media engine 316 may include a media identifier module (not shown) configured to generate a media identifier for at least one media, or the media provider data module 404 and user preference module 406 may be optional.

Referring now to FIG. 5A, a block diagram of an exemplary media 500 is shown. A copy of the media 500 can be dragged and dropped onto the user's desktop or transferred to another user. In some embodiments, the copy of the media 500 may additionally be customized to the user preferences or updated as vendor inventory changes. The media 500 (or copy of the media 500) comprises graphics and text data 502, a parent address 504, media provider field information 506, and a media identifier 508.

The graphics and text data 502 includes parts of the media 500 that are static (e.g., not customized or updated). The static data may include the logos, text or images, and dimensions of the media 500. In exemplary embodiments, the static data may include generic media provider data that is not customized to any user 104. If the media 500 is not customizable, then the graphics and text data 502 will comprise the entire media. In further embodiments, the graphics and text data 502 may include metadata about the fields used to customize the media.

The parent address 504 is an identifier indicating a media provider 106 and contact information for the media provider 106. In some embodiments, when the media is transferred, the user media engine 316 relays a message to the media provider 106 using the parent address 504 so that the media can be updated or customized to the recipient.

The optional media provider field information 506 comprises information transferred to the user 104 from the vendor 114 or media provider 106, and in advertisement embodiments, directly from the vendor's inventory database 116. The media provider field information 506 can be transferred with the media 500, or alternatively, a set of media provider field information may be transferred with a copy of the media 500. The media provider data module 404 may then select the media provider field information 506 from the set according to the user preferences as discussed herein.

The media identifier 508 is used to identify a specific version of the media 500 that the user 104 views due to customizing or updating of the media 500. The tracking module 408 uses the media identifier 508 to maintain a history of the media 500. The media identifier 508 may also change, for example, when the media 500 is dragged and dropped by the user 104 and when the media 500 is received by another user after being transferred.

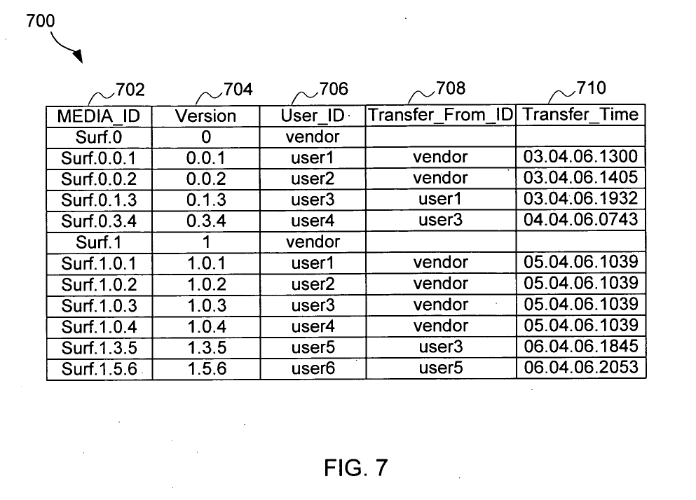

The media identifier 508 may be fully or partially generated by the tracking module 408, a history module in the online services server 102, or at the vendor 114. For example, the media identifier 508 may only comprise a name of the media at the user 104, but when a copy of a communication having a copy of the media is routed through the media provider 106 or vendor 114, the media provider 106 or vendor 114 can detect the sender and recipient and incorporate this information into the media identifier 508. The media identifier 508 will be discussed in more detail in connection with FIG. 7.

Referring now to FIG. 5B, a sample media 512 is shown. In this example, the media 512 is an advertisement. In other embodiments, the media 512 may comprise an article such as a news story, a sound or movie clip, a recipe, or the like. The graphics and text data 502 is shown as media body 514 having optional fields 516 and an optional link 518. The media body 514 has a length dimension and a width dimension dictated by the graphics and text data 502. The graphics and text data 502 may also include image, text, and designated locations and dimensions for fields 516. In one embodiment, the graphics and text data 502 comprises the entire media.

The media body 514 may also comprise the optional link 518 configured to activate the communication interface 510 when a user 104 clicks on the link 518. The link 518 provides an alternate way to contact the vendor 114 or media provider 106. When the user 104 clicks the link 518, real-time interaction with the vendor 114 or media provider 106, such as through online messaging or VoIP, is provided.

In further embodiments, the optional fields 516 are components of the media 512 that are updatable or customizable. In customizable media embodiments, after a copy of the media 512 is dropped onto the user device 300 (e.g., the desktop) or received from another user 104, these fields 516 are customized to the user 104. Additionally, as inventory changes or a news story is updated, for example, some of these fields 516 may be updated. The fields 516 may each display a piece of field information 506 according to metadata associated with each field. For example, if the media 500 comprises an advertisement, field 1, 516a, may display special promotions or remaining inventory in the vendors' 114 inventory database 116. Field 2, 516b, in exemplary embodiments, may display price information, for example, a current price as obtained from the vendor's inventory database 116. Finally, field 3, 516c, may display content provider contact information. The fields may be used for different information in other types of media 500. For example, recipes may include fields to indicate low fat or low sugar variations. News stories may add fields 516 as news events develop to provide continuous coverage of events or a local perspective. Any number of fields 516 may be embodied in the sample media 512.

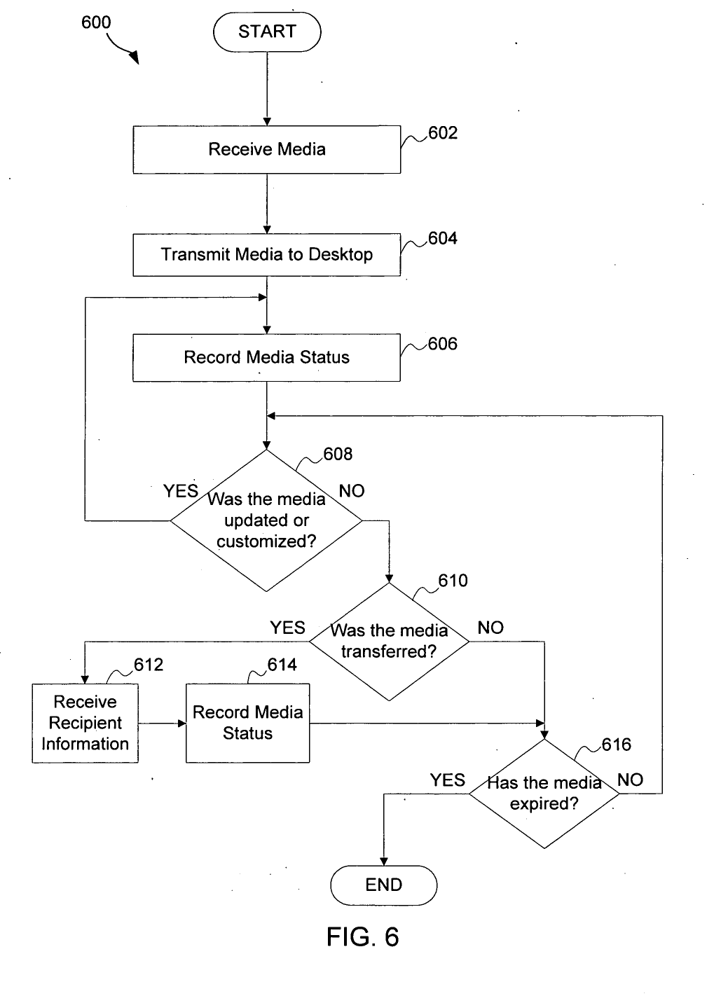

Referring now to FIG. 6, a flowchart 600 of an exemplary media 500 tracking method is shown. This method allows the vendors 114 or media providers 106 to track media 500 (or version of the media 500) as the media 500 is updated, customized, and/or transferred. Tracking the media 500 provides feedback to the vendor 114 and media provider 106 relating to the effectiveness and the audience of the media 500. The user 104 and e-community 110 also benefit by receiving updates and customizations to the media 500, and more relevant media 500 in the future.

In step 602, the user 104 receives a copy of the media. The user 104 may receive the copy of the media from another user 104, the e-community 110, the vendor 114, or the media provider 106. In other instances, the user 104 may have dragged and dropped the copy of the media 500 from a website or from the e-community 110.

In step 604, the media 500 is placed on the desktop or another designated location on the user device 300. In exemplary embodiments, the media engine 316 creates a version of the media from the graphics and text data 502, the field information 506, and/or the user information 504. In exemplary embodiments, the tracking module 408 may assign a media identifier 508 to the media 500. The media identifier 508 will be discussed in greater detail in connection with FIG. 7.

In step 606, the tracking module 408 records the media status and transmits the media status to a database (e.g. the database 304 of FIG. 3, the database 210 of FIG. 2, or a database at the vendor 114 or media provider 106 associated with the media 500). The media status may be stored, for example, in database 304 and accessed or queried later by a vendor 114 and media provider 106. The tracking module 408 may periodically transmit media status records to the vendor 114, the media provider 106, or optional online services server 102. In some embodiments, the media status comprises the media identifier 508, some user information 504 and/or some field information 506. Alternatively, the media identifier 508 may be formatted to include some user information 504 and/or field information 506. The media status may also include data relating to the source of the media 500, for example, a vendor 114, an RSS feed, or an e-community 110. In a further embodiment, the status may be locally stored until a predetermined time when the status is forwarded to the media provider 106 and/or vendor 114.

In step 608, the media engine 316 determines whether the copy of the media 500 has been updated or customized by the media provider data module 404 or the user preferences module 406. These changes are tracked to provide dynamic data relating to the effectiveness of the media 500 upon each update to the copy of the media 500. For example, updating a price field, such as field 516b to reflect a lower price may increase sales of a product.

If the media engine 316 determines that the copy of the media 500 has been changed, the media identifier 508 may be revised. The tracking module will repeat step 606 by determining the new media status and transmitting the new media status to the database.

If the copy of the media 500 is not updated or customized, the media engine 316 determines whether the copy of the media 500 is transferred to another user 104 or to an e-community 110 in step 610. These transfers are tracked to provide data relating to the referral rate of the media 500. For example, if the media 500 is referred many times, the media 500 is effectively attracting user 104 interest. In combination with actual sales data, a vendor 114 or media provider 106 can determine whether the media 500 is reaching a relevant audience. If the media 500 has been transferred, the media engine continues to steps 612, 614, and 616. If the media 500 has not been transferred, the media engine continues to step 616.

In step 612, the tracking module 408 receives recipient information from the transfer module 410. The recipient may be another user 104 or an e-community 110. The recipient information may comprise a user name, an e-mail address, or other unique identifier. This recipient information may be integrated into a revised media identifier 508.

In step 614, the tracking module 408 records the new media status and transmits the new media status to the database (e.g. database 304 or database 210, or a database at the vendor 114 or media provider 106 associated with the media 500). In some embodiments, the new media status comprises the media identifier 508, the user information 504, and/or the media provider field information 506. In alternative embodiments, the media identifier 508 may be formatted to include some user information 504 and/or some media provider field information 506. The new media status may also include data relating to the source of the media 500, for example, the vendor 114 or the e-community 110. More specifically, in step 614, the new media status may additionally include, or the media identifier 508 may be further formatted to include, recipient information. The new media status and/or the media identifier 508 may also comprise a counter configured to indicate a number of transfers. Additionally, the tracking module 408 in the sender's and/or the recipient's user device 300 may perform steps 612 and 614.

In step 616, the media engine 316 determines whether the media 500 has expired. The expiry of the media 500 may be in the form of an expiration date included in the graphics and text data 502, an update received from the media provider 106, or a result of a user 104 deleting the media 500 from the desktop of the user device 300, for example. If the media 500 has not expired, the media 500 continues to be monitored as discussed in previous steps 608 through 616. It should be noted that steps 606, 608, 610, and 616 may be performed simultaneously or in a different order in alternative embodiments.

Referring now to FIG. 7, a table 700 used in an exemplary tracking method to maintain a history of the media 500 is shown. The table 700 may be stored in any database or repository associated with the system. In combination with sales data, the history allows the vendor 114 or the media provider 106 to track the movement and effectiveness of the media 500 as the media 500 is transferred, updated, and/or customized to specific users 104. The ability to track the media 500 allows the vendors 114 and the media providers 106 to, for example, better allocate online publishing budgets and to push subsequent media 500 that is relevant to users 104.

In column 702, a “MEDIA_ID” (e.g., media identifier 508 of FIG. 5A) is listed for each separate instance of the media 500 as the media 500 is transferred, updated, and customized. In this particular example, the media 500 is generically identified as “Surf” and relates to a Hawaiian tour package advertisement shown as sample media 512. Following the generic identifier is a version number. The version number is discussed with respect to column 704.

In column 704, a unique version number is listed for each separate instance of the media 500. In the present embodiment, the version number generally comprises three digits separated by decimal points, indicating an update number, a source of the media 500, and the recipient user 104 of the media 500. For simplicity, it is assumed that media 500 is automatically customized to the recipient. For example, for the copy of the media 500 having the MEDIA_ID “Surf.1.0.2,” the update number is “1,” a source identifier is “0” (i.e., from the media provider 106), and a recipient identifier is “2.” The update number is a tally of a number of times a media provider 106 updates the media 500 with, for example, price information, inventory information, or the like. An original version of the media 500 is version “0.”

In exemplary embodiments, when media 500 is updated by the vendor 114 or media provider 106, the copies of the media(s) 500 that have been transferred instantly update. For example, user1, user2, user3, and user4 receive the first update (e.g., version 1) from the vendor 114 at the same time regardless of their source of the media 500. In this example, a copy of an updated version of media 500 that is not transferred from a vendor 114 is identified by a single digit version number.

The second digit in the version number is the source identifier. This digit indicates where the specific version of the media was obtained/received from. Thus, for example, the media ID “Surf.1.0.2” is received from the vendor 114 or media provider 106 since the “0” indicates an original publisher. In some embodiments, a “0” source identifier may indicate that the user obtained the media 500 themselves (e.g., dragged and dropped onto their user device 300). A non-zero number indicates that the media 500 is referred to the recipient by a third source such as another user 104 or an e-community 110.

The third digit is the recipient identifier. The recipient identifier indicates the user 104 who has a saved copy of the media on their user device 300. In further embodiments, the media 500 is automatically customized to the recipient, thus, the recipient identifier also includes customization information. In alternate embodiments, one or more digits can be added to the version number to indicate other data, such as customization data. Additional formats for the version number will be apparent to one skilled in the art.

Column 706, “User_ID,” indicates the recipient of the media 500 as well as customization information, where the media 500 is automatically customized to the recipient. The “User_ID” additionally provides the ability to determine, for example, users 104 who have a copy of the media 500. This is helpful in determining the relevance of the media 500 to an audience.

Column 708, “Transfer_From_ID” indicates the source of the media 500. The source may be the vendor 114, the media provider 106, another user 104, or the e-community 110. This column provides the ability to track the media 500 as it is transferred between users. For example, user4 receives the initial version (i.e., “Surf.0”) of the media 500 from user3 who in turn received the media 500 from user1 who received the media 500 from the media provider 106.

Column 710, “Transfer_Time,” indicates when the present version of the media 500 at the recipient is transferred from the source. In this example, the time is recorded as “day.month.year.time.”

It should be noted that table 700 is an illustrative example of how a history may be maintained. Other structures, formats, columns, or fields may be utilized. The table 700 may include greater or fewer columns to indicate data relating to the copy of the media 500. Additional fields may include data such as customization data, how many times a user 104 has clicked on the media 500, how long the user 104 has had the media 500, and an original publisher of the media 500. In such embodiments, the customization data, for example, may be organized by a field (e.g., field 516a) or, if the media provider field information is organized into data sets for multiple fields based on similar user preferences, by sets of fields (e.g., fields 516a-c).

While embodiments of the present invention have been described above in reference to online media 500 in an e-commerce environment, embodiments of the present invention may also be practiced in non e-commerce environments, such as a peer-to-peer environment where each user device 300 comprises the core services module 306.

The above-described functions and components can be comprised of instructions that are stored on a storage medium. The instructions can be retrieved and executed by a processor. Some examples of instructions are software, program code, and firmware. Some examples of storage medium are memory devices, tape, disks, integrated circuits, and servers. The instructions are operational when executed by the processor to direct the processor to operate in accord with embodiments of the present invention. Those skilled in the art are familiar with instructions, processor(s), and storage medium.

The present invention is described above with reference to exemplary embodiments. It will be apparent to those skilled in the art that various modifications may be made and other embodiments can be used without departing from the broader scope of the present invention. Therefore, these and other variations upon the exemplary embodiments are intended to be covered by the present invention.

What is claimed is:

1. A system for maintaining a history of media comprising:
a tracking module configured to determine a media status, the media status comprising at least a portion of a media identifier.

2. The system of claim 1 wherein the tracking module is further configured to determine whether the media has been updated, customized, or transferred.

3. The system of claim 1 wherein the media identifier comprises a media name and a version number.

4. The system of claim 1 further comprising a monitor module configured to receive and store the media status.

5. The system of claim 1 wherein a history module is configured to provide a graphical representation of the media status to a requester.

6. The system of claim 1 wherein the media status further comprises a user identifier.

7. The system of claim 1 wherein the media status further comprises a transfer-from identifier.

8. A machine readable medium having embodied thereon a program, the program being executable to provide a method for maintaining a history of media, the method comprising:
receiving the media at a local location;
determining a media status, the media status indicating a version of the media at the local location; and
transmitting the media status to a memory device.

9. The machine readable medium of claim 8 wherein determining the media status comprises determining an original publisher of the media.

10. The machine readable medium of claim 8 wherein determining the media status comprises determining the version of the media.

11. The machine readable medium of claim 8 wherein the method further comprises storing the media status in a history database.

12. The machine readable medium of claim 8 wherein the method further comprises providing a graphical representation of the history to a requester.

13. The machine readable medium of claim 8 wherein the method further comprises determining a transfer-from identifier of the media received at the local location.

14. The machine readable medium of claim 8 wherein the method further comprises determining a transfer time associated with the media received at the local location.

15. A method of tracking an online media comprising:
receiving a media status from at least one user device, the media status comprising at least a media identifier;
storing the media status in a history database; and
providing the media status to a requester.

16. The method of claim 15 further comprising associating a source with the media status.

17. The method of claim 15 further comprising associating a transfer time with the media status.

18. The method of claim 15 further comprising associating a version number with the media status.

19. The method of claim 15 further comprising associating a user preference with the media status.
